(19) United States
(12) Patent Application Publication
(10) Pub. No.: US 2012/0310801 A1
(43) Pub. Date: Dec. 6, 2012

(54) POWER USAGE CALCULATION SYSTEM

(75) Inventors: Yuichi KOMANO, Kanagawa (JP); Shinji Yamanaka, Tokyo (JP); Satoshi Ito, Tokyo (JP); Toshinari Takahashi, Tokyo (JP)

(73) Assignee: Kabushiki Kaisha Toshiba, Minato-ku (JP)

(21) Appl. No.: 13/481,213

(22) Filed: May 25, 2012

Related U.S. Application Data
(63) Continuation of application No. PCT/JP2009/070050, filed on Nov. 27, 2009.

(51) Int. Cl. G08C 15/06; G06Q 30/04

(52) U.S. Cl. 705/34; 340/870.02

(57) ABSTRACT

According to an embodiment, in a power usage calculation system, a data management system connected to electric power meters adding up power usage of electric apparatuses and an energy management system are interconnected through a network. Plural pieces of the first partial information are calculated by using the power usage added up by the electric power meters. The plural pieces of the first partial information are stored in storage servers. Each storage server calculates second partial information by using a plurality of pieces of the first partial information of the power usage added up by the electric power meters and transmits the calculated second partial information to the energy management system. The energy management system receives the second partial information respectively transmitted from the storage servers and calculates a total amount of the power usage added up by the electric power meters by using the received second partial information.

### CROSS-REFERENCE TO RELATED APPLICATIONS

This application is a continuation of PCT international application Ser. No. PCT/JP2009/070050 filed on Nov. 27, 2009 which designates the United States; the entire contents of which are incorporated herein by reference.

### FIELD

Embodiments described herein relate generally to a power usage calculation system.

### BACKGROUND

In addition to general power generation of nuclear power, thermal power, and the like, when renewable energy such as sunlight or wind power is used together, in order to stabilize the quality of electric power, a next-generation power grid (smart grid) has been built. In the next-generation power grid, a smart meter (referred to as an SM) that sums up power usage and a home server that manages electric apparatuses are installed to each house or each business site. The SM communicates with a meter data management system (MDMS) through the power grid. The MDMS receives power usage from the SM located in each house or each business site with a predetermined time interval and stores the power usage in a storage server. Based on the power usage of a plurality of houses and business sites, which is collected in the MDMS, an energy management system (EMS) performs power control such as requesting the SM or the home server located in each house or each business site for suppressing the usage of electric power or controlling charging/discharging a storage battery connected to the power grid.

As an application server that is connected to a power grid and implements various applications, for example, there is a billing server that is managed by a provider. Such a billing server performs a billing process based on the power usage of each house or each business site that is collected in the MDMS. In a case where a request for reading power usage is received from the SM, the MDMS provides information that is managed by the MDMS. Accordingly, the MDMS is considered to store therein the power usage of each house or each business site. However, by a supervisor of a storage server of the MDMS or an authorized user intruding into the storage server acquiring the power usage of each house, whether or not the house or the business site is at home or at work, the state of an activity, and the like can be estimated. This leads to invasion of privacy.

### BRIEF DESCRIPTION OF THE DRAWINGS

FIG. 1 is a diagram that illustrates an example of the configuration of a power usage calculation system according to a first embodiment;

FIG. 2 is a flowchart that illustrates the sequence of a total power usage calculating process;

FIG. 3 is a flowchart that illustrates the sequence of a billing system process;

FIG. 4 is a flowchart that illustrates the sequence of a reading request process;

FIG. 5 is a diagram that illustrates an example of the configuration of a power usage calculation system according to a second embodiment;

FIG. 6 is a flowchart that illustrates the sequence of a total power usage calculating process;

FIG. 7 is a flowchart that illustrates the sequence of a reading request process;

FIG. 8 is a flowchart that illustrates the sequence of a total power usage calculating process according to a third embodiment;

FIG. 9 is a flowchart that illustrates the sequence of a reading request process; and

FIG. 10 is a flowchart that illustrates the sequence of a billing system process according to a modified example.

### DETAILED DESCRIPTION

According to an embodiment, a power usage calculation system in which a data management system, which is connected to a plurality of electric power meters adding up power usage of electric apparatuses, and an energy management system are interconnected through a network. The power usage calculation system includes a first calculator configured to calculate a plurality of pieces of first partial information by using the power usage added up by the electric power meters. The data management system includes a plurality of storage servers configured to store therein the plurality of pieces of first partial information, respectively. Each of the storage servers includes a second calculator configured to calculate second partial information by using a plurality of pieces of the first partial information of the power usage added up by the plurality of the electric power meters; and a transmission unit configured to transmit the second partial information to the energy management system. The energy management system includes a first reception unit configured to receive the second partial information transmitted from the plurality of storage servers; and a third calculator configured to calculate a total amount of the power usage added up by the plurality of the electric power meters by using a plurality of pieces of the second partial information. The first partial information is information that cannot specify privacy information.

Hereinafter, various embodiments will be described in detail with reference to the accompanying drawings.

Here, first, an outline of a power usage calculation system will be described. The power usage calculation system includes a plurality of storage servers that are connected to the above-described SM, calculates first partial information that is necessary for each storage server to calculate second partial information or third partial information that is necessary for restoring the input of an application based on the power usage of each house or each business site in accordance with privacy information to be protected, and stores calculation results in the storage servers. Such partial information is information that is used for restoring information used by an application to be described later. It is preferable that the partial information is information that cannot specify the privacy information. For example, in a case where power usage per unit time corresponds to the privacy information, a plurality of pieces of the first partial information is calculated based on the power usage per unit time and is stored in the storage servers. Alternatively, in a case where a place at which electric power is used corresponds to the privacy information, a plurality of pieces of the first partial information is calculated based on the power usage collected by a plurality of SMs and is stored in the storage servers. The privacy information is information that specifies a taste or a behavior of an individual or a group. In the privacy information, although information that specifies an individual or a group is included, information that does not specify an individual or a group but specifies the trend of tastes or behaviors of an individual or a group is also included. A determination on whether or not power usage per unit time corresponds to privacy information may be performed in advance or may be dynamically performed. In a case where the power usage per unit time does not correspond to the privacy information, calculation of the above-described first partial information and storage thereof into the storage server may be performed.

In addition, for example, an application that performs a billing process in proportion to power usage has an input that is a precise value of the power usage of each house or each business site. In such a case, the first partial information is calculated based on the power usage of each home or each business site such that a precise value of the power usage of each house or each business site is calculated based on the second partial information or the third partial information that is calculated by a plurality of the storage servers, and the calculated first partial information is stored in each storage server. An application that determines whether or not the power usage is a threshold value or less does not need a precise value of the power usage of each house or each business site as an input. Accordingly, for example, in a case where two storage servers are used, it can be reliably checked that the power usage of each house or each business site is the threshold value or less when: the storage server outputs “1” as the first partial information in a case where the power usage of each house or each business site, which is calculated from the first partial information that is calculated based on the power usage of each house or each business site, exceeds a half of a threshold value and outputs “0” otherwise; and the two storage serves output “0” together. In addition, there is also a case where the storage server calculates the second partial information or the third partial information that is necessary for restoring inputs of a plurality of applications by using the same first partial information that is calculated based on the power usage of each house or each business site.

In the embodiments to be described below, an example will be described in which the power usage of each house per first unit time is concealed, and an EMS that has total power usage of a plurality of houses per the first unit time as its input and a billing server that has power usage of each house per second unit time as its input are used as application servers. In addition, although the power usage of each house is concealed in the embodiments, the power usage is not limited to each house, and power usage of an adding-up range (adding-up unit) of a smart meter that uses electric power may be concealed, and, in such a case, a “house” in the present specification may be paraphrased by an “adding-up range (adding-up unit)”.

### First Embodiment

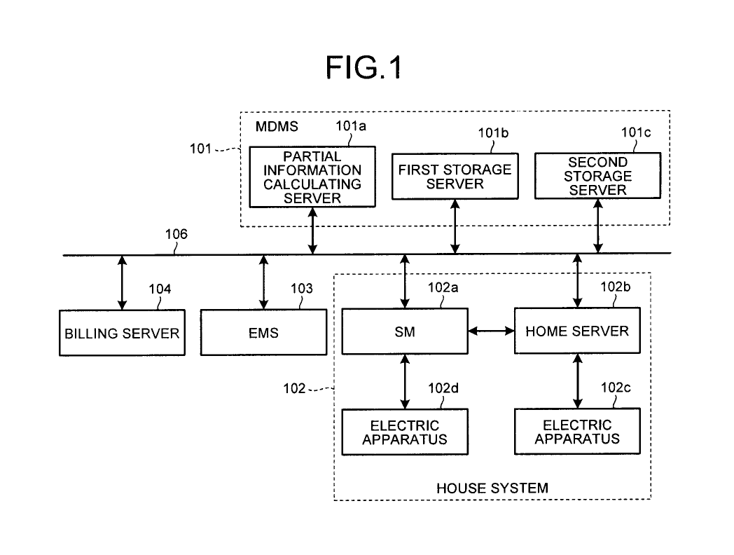

FIG. 1 is a diagram that illustrates an example of the configuration of a power usage calculation system according to this embodiment. As illustrated in the figure, the power usage calculation system has a configuration in which a meter data management system (MDMS) 101, a house system 102, an energy management system (EMS) 103, and a billing server 104 are interconnected through a network 106. For the simplification of the figure, although only one house system 102 is illustrated, a plurality of the house systems 102 may be connected to the power usage calculation system. The network 106, for example, is a local area network (LAN), an intranet, Ethernet (registered trademark), the Internet, or the like. The MDMS 101 is a system that collects and manages power usage of each house through the network 106 and includes a partial information calculating server 101a, a first storage server 101b, and a second storage server 101c. The house system 102 is a system that is disposed in a house and adds up the power usage of electric apparatuses used in the house and includes a smart meter (SM) 102a, a home server 102b, an electric apparatus 102c, and an electric apparatus 102d. The electric apparatus 102c is connected to the home server 102b in a wired or wireless manner. In addition, the electric apparatus 102d is connected to the SM 102a in a wired or wireless manner. The SM 102a adds up the power usage within the house system 102.

In addition, to the house system 102, identification information (referred to as house identification information) used for identifying the house system is assigned, and it is assumed that the home server 102b and the SM 102a store the house identification information that is assigned to the house system 102. In addition, it is assumed that all the partial information calculating server 101a, the first storage server 101b, the second storage server 101c, the EMS 103, and the billing server 104 store the house identification information of each house system 102 that is connected to the power usage calculation system.

In the power usage calculation system having such a configuration, the partial information calculating server 101a calculates a plurality of pieces of the first partial information by using the power usage added up by the SM 102a. In addition, the information added up by the SM 102a is information in which at least house identification information and power usage are associated with each other, and the partial information calculating server 101a calculates the plurality of pieces of the first partial information by using the associated information. However, additional information other than the house identification information and the power usage may be associated therewith. Information relating the power usage of a calculation source can be restored by integrating the plurality of pieces of the first partial information. More specifically, the first partial information is information that is calculated based on the power usage added up by one or a plurality of SMs, a predetermined number of pieces of the first partial information is included, whereby the value of the power usage, information on whether or not the power usage exceeds a threshold value, and the like are calculated. The plurality of pieces of the first partial information is stored in the first storage server 101b and the second storage server 101c in a fragmented manner. The first storage server 101b and the second storage server 101c calculate the second partial information or the third partial information in accordance with the purpose of the application by using the plurality of pieces of the first partial information. Here, the second partial information is information that is calculated by a predetermined number of applications arranging the first partial information in accordance with the purposes of the applications and is information that is used for calculating an input of the application such as a total amount of power usage of individual houses or business sites (total power usage) or the like. Similarly in the third partial information, the units of calculation are different from those of the second partial information. Here, as the first partial information that is used for calculating the second partial information or the third partial information, a plurality of pieces of the first partial information calculated based on the power usage added up by another SM 102a may be used, or a plurality of pieces of the first partial information that is calculated based on power usage added up by the SM 102a at another time may be used. The applications are various functions such as power control that is implemented by the EMS 103 to be described later, a billing process that is implemented by the billing server 104, and the like that are implemented by the other application servers. The first storage server 101b and the second storage server 101c respectively transmit the second partial information and the third partial information to the application servers thereof. Thereafter, the application server restore an input of the application based on a plurality of pieces of the second partial information or the third partial information that has been received and performs the process of the application. In other words, the application server integrates a plurality of pieces of the first partial information, and, by adding up the pieces of the first partial information in accordance with the units of the calculation, the value of the total power usage per calculation unit, information on whether or not the value exceeds the threshold value, or the like can be restored.

Here, the hardware configuration of the partial information calculating server 101a, the first storage server 101b, the second storage server 101c, the SM 102a, the home server 102b, the EMS 103, and the billing server 104 will be described. Each of these devices includes a controller such as a central processing unit (CPU) that controls the whole device, a main storage unit such a as read only memory (ROM) or a random access memory (RAM) that stores various kinds of data and various programs, an auxiliary storage unit such as a hard disk drive (HDD) or a compact disk (CD) drive device that stores various kinds of data and various programs, and a bus that connects these components and has a hardware configuration using a general computer. In addition, the partial information calculating server 101a, the first storage server 101b, the second storage server 101c, the home server 102b, the EMS 103, and the billing server 104 further include communication interfaces (I/F) that perform communication through the network 106. The home server 102b may further include a display unit that displays various kinds of information such as power usage.

Next, in such a hardware configuration, various functions that are realized by the CPU, which executes various programs stored in the main storage unit or the auxiliary storage unit, of each one of the partial information calculating server 101a, the first storage server 101b, the second storage server 101c, the SM 102a, the home server 102b, the EMS 103, and the billing server 104 will be described.

The SM 102a mechanically adds up power usage z_{i, j} of the electric apparatuses 102c and 102d for every first unit time. Here, in each subscript, i and j represent house identification information and a measurement target time, respectively. Alternatively, the SM 102a may add up the power usage of the electric apparatuses 102c and 102d for every first unit time by, after device authentication of the electric apparatus 102d is performed, writing the power usage of the electric apparatus 102d, writing the power usage of the electric apparatus 102c that is managed by the home server 102b to be described later, and the like at least once per first unit time. The first unit time represents a time interval at which the EMS 103 to be described later controls the power grid by calculating the total amount of power usage (total usage amount) and, for example, is a time interval of 30 minutes or the like. In addition, the SM 102a stores an encryption key ek. Then, the SM 102a calculates a ciphertext by encrypting the added-up power usage with the encryption key ek and stores the ciphertext. The ciphertext of the power usage is read out by the partial information calculating server 101a. In addition, the SM 102a serves as storage means for writing or reading information into or from at least one of the electric apparatus 102d, the home server 102b, the partial information calculating server 101a, the first storage server 101b, and the second storage server 101c but does not have a function of voluntarily transmitting information.

The home server 102b performs management of power usage of the electric apparatus 102c arranged thereunder, control of the electric apparatus 102c arranged thereunder, and the like. In a case where the SM 102a adds up power usage of a house system based on the written power usage, the power usage of the electric apparatus 102c arranged thereunder is measured at least once in the first unit time, and the value is written into the SM 102a. In addition, the home server 102b stores a decryption key dk′ corresponding to an encryption key ek′ that is stored by the first storage server 101b to be described later and a decryption key dk″ corresponding to an encryption key ek″ that is stored by the second storage server 101c. Then, the home server 102b generates a reading request Req_i that is used for requesting for reading power usage and writes the reading request into the SM 102a, and, in accordance with the reading request Req_i, performs a reading process by reading out a ciphertext of a one-side piece of the first partial information that is written into the SM 102a by the first storage server 101b to be described later and decrypting the read-out ciphertext by using the decryption key dk′ and reading out a ciphertext of the other-side piece of the first partial information that is written into the SM 102a by the second storage server 101c to be described later and decrypting the read-out ciphertext by using the decryption key dk″. A display of the power usage in the reading process may be performed by using an output terminal that is connected to the home server 102b or an output terminal that is connected to an in-house system.

The partial information calculating server 101a stores a decryption key sk corresponding to the encryption key ek that is used for encryption by the SM 102a and acquires power usage z_{i, j} in the first unit time, which is added up by the SM 102a, by reading out a ciphertext of power usage in the first unit time from the SM 102a and decrypting the ciphertext using the decryption key sk. Then, the partial information calculating server 101a calculates a plurality of pieces of the first partial information based on the power usage z_{i, j} using a partial information calculating algorithm D. Here, as represented in Equation 1, two pieces of the first partial information are calculated, one of them is denoted by the one-side piece of the first partial information x_{i, j}, and the other is denoted by the other-side piece of the first partial information y_{i, j}.

D(z_{—}{i,j})=(x_{—}{i,j},y_{—}{i,j}) (1)

The partial information calculating server 101a transmits the one-side piece of the first partial information x_{i, j} to the first storage server 101b out of the plurality of pieces of the first partial information and transmits the other-side piece of the first partial information y_{i, j} to the second storage server 101c.

In addition, the partial information calculating server 101a transmits the reading request Req_i that is written into the SM 102a to the first storage server 101b and the second storage server 101c.

When first partial information x_{—}{1, j}, x_{—}{2, j}, . . . , x_{n, j} and house identification information of each house are received for every first unit time, the first storage server 101b, for example, stores them in the auxiliary storage unit in association with a time (referred to as a power usage time). Then, when one-side pieces of the first partial information of a plurality of houses are collected, the first storage server 101b calculates the one-side piece of the second partial information s_j=A_x (x_{—}{1, j}, x_{—}{2, j}), . . . , x_{n, j}) of power usage of all the houses in the first unit time by integrating all the one-side pieces of the first partial information x_{—}{1, j}, x_{—}{2, j}, . . . , x_{n, j} of the houses by using an integration algorithm A_x and transmits the calculated second partial information to the EMS 103. The plurality of houses may be all or some of the house systems 102 that are connected to the power usage calculation system.

In addition, in accordance with a billing process command that is transmitted from the billing server 104 to be described later, the first storage server 101b calculates a one-side piece of the third partial information “u_i=A_x′ (x_{i, 1}, x_{i, 2}, . . . , x_{i, m})” of power usage of each house in the second unit time by reading out one-side pieces of the first partial information x_{i, 1}, x_{i, 2}, . . . , x_{i, m} belonging to the second unit time out of one-side pieces of the first partial information corresponding to the house identification information of each house from the auxiliary storage unit and integrating a plurality of one-side pieces of the first partial information x_{i, 1}, x_{i, 2}, . . . , x_{i, m} using the integration algorithm A_x′ and transmits the calculated third partial information to the billing server 104. The second unit time represents a billing process unit and, for example, is one month or the like. In addition, the second unit time is formed by m of the first unit times. The first partial information that belongs to the second unit time, for example, is the first partial information that is associated with the power usage time between the start time of the second unit time as a period, during which the power usage of the calculation source of the first partial information is added up, and the end time of the second unit time.

In addition, the first storage server 101b stores the encryption key ek′ and calculates a ciphertext c_i′ by reading out the first partial information x_{i, 1}, x_{i, 2}, . . , x_{i, l} corresponding to a power usage time within the reading request period out of one-side pieces of the first partial information that is stored in association with the house identification information that is included in a reading request Req_i in accordance with the reading request Req_i transmitted from the partial information calculating server 101a and encrypts the read-out first partial information with the encryption key ek′ to calculate a ciphertext c_i′, and writes the ciphertext into the SM 102a.

When the other-side pieces of the first partial information y_{—}{1, j}, y_{—}{2, j}, . . . , y_{n, j} of the respective houses are received for every first unit time, the second storage server 101c stores the received first partial information, for example, in the auxiliary storage unit in association with the time (power usage time). Then, when the other-side pieces of the first partial information of a plurality of houses are collected, the second storage server 101c calculates the other-side piece of the second partial information t_j=A_y (y_{—}{1, j}, y_{—}{2, j}, . . . , y_{n, j}) of the power usage of all the houses in the first unit time by integrating the other-side pieces of the first partial information y_{—}{1, j}, y_{—}{2, j}, . . . , y_{n, j} of all the houses by using an integration algorithm A_y and transmits the calculated second partial information to the EMS 103.

In addition, in accordance with a billing process command that is transmitted from the billing server 104 to be described later, the second storage server 101c calculates the other-side piece of the third partial information “v_i=A_y’ (y_{i, 1}, y_{i, 2}, . . . , y_{i, m})” of the power usage of each house in the second unit time by reading out the other-side pieces of the first partial information y_{i, 1}, y_{i, 2}, . . . , y_{i, m} belonging to the second unit time out of the other-side pieces of the first partial information corresponding to the house identification information of each house from the auxiliary storage unit and integrating a plurality of the other-side pieces of the first partial information y_{i, 1}, y_{i, 2}, . . . , y_{i, m} using the integration algorithm A_y′ and transmits the calculated third partial information to the billing server 104.

In addition, the second storage server 101c stores the encryption key ek″ and calculates a ciphertext c_i′ by reading out the other-side pieces of the first partial information y_{i, 1}, y_{i, 2}, . . . , y_{i, l} corresponding to a power usage time within the reading request period out of the other-side pieces of the first partial information that is stored in association with the house identification information that is included in a reading request Req_i in accordance with the reading request Req_i transmitted from the partial information calculating server 101a and encrypts the read-out first partial information with the encryption key ek′ to calculate a ciphertext c_i′, and writes the ciphertext into the SM 102a.

The EMS 103 performs power control based on the total amount (total power usage) of electricity usage of all or some of houses whose house systems 102 are connected to the power usage calculation system in the first unit time. In the power control, for example, in a case where the total power usage exceeds an upper limit threshold value, a control signal requesting for suppressing the total usage amount is transmitted to the SM 102a or the home server 102b, and, in a case where the total power usage is below a lower limit threshold value, a storage battery is charged. In other to acquire the total power usage, when a one-side piece of the second partial information s_j transmitted from the first storage server 101b and the other-side piece of the second partial information t_j transmitted from the second storage server 101c are received for every first unit time, the EMS 103 restores the total amount of power usage (total power usage) Σ_{i=1}̂n z{i, j}=D̂{−1} (s_j, t_j) of the above-described plurality of houses in the first unit time by integrating a plurality of pieces of the second partial information s_j and t_j using a restoration algorithm D̂{−1}.

The billing server 104 performs a billing process based on the amount of electricity usage for each house. More specifically, the billing server 104 transmits a billing process command that commands the execution of a billing process to the first storage server 101b and the second storage server 101c every second unit time, integrates the one-side piece of the third partial information u_i received from the first storage server 101b and the other-side piece of the third partial information v_i received from the second storage server 101c using a restoration algorithm D̂{−1} in accordance with the billing process command, the total power usage Σ_{j=1}̂m z{i, j}=D̂{−1} (u_i, v_i) of each house in the second unit time is restored, and a billing process for each house is performed based on the restored total power usage.

Here, examples of the partial information calculating algorithm D, the integration algorithms A_x, A_x′, A_y, and A_y′, and the restoration algorithm D̂{−1} will be described. In the partial information calculating algorithm D, for example, x is randomly generated with z used as an input, it is set such that y=z−x, and (x, y) is output. At this time, in the integration algorithms A_x, A_x′, A_y, and A_y′, A_x (w_{—}1, w_{—}2, . . . , w_k)=A_x′ (w_{—}1, w_{—}2, . . . , w_k)=Σ_{i=1}̂k w_i, A_y (r_1, r_2, . . . , r_l)=A_y′ (r_1, r_2, . . . , r_l)=Σ_{i=1}̂l r_i are output. In the restoration algorithm D̂{−1}, D̂{−1} (w, r)=w+r is output. The partial information that is calculated by the partial information calculating algorithm D of this example is acquired by dividing the amount of electricity usage into a plurality of parts, and the amount of electricity usage that is restored by the integration algorithms A_x, A_x′, A_y, and A_y′ is integrated by adding the partial information together.

In the partial information calculating algorithm D, in a case where x is randomly generated as a value that is zero or more and z or less, y is a non-negative value. At this time, although, in a case where the value of z is small, the values of x and y are also small, in a case where the value of z is large, there is a case where the values of x and y are large. Accordingly, since the information of the value of z can be acquired based on the values of x and y, there is a case where the concealment of the value of z is insufficient. By selecting a negative value or a value greater than z as x, the value of z can be further concealed.

In addition, for a sufficiently large value b, an algorithm using the remainder of b may be configured. In the partial information calculating algorithm D, a value x that is zero or more and less than b is randomly generated with z used as an input, and y=z−x mod b is output. In the integration algorithms A_x, A_x′, A_y, and A_y′, A_x (w_{—}1, w_{—}2, . . . , w_k)=A_x′ (w_{—}1, w_{—}2, . . . , w_k)=Σ_{i=1}̂k w_i mod b and A_y (r_{—}1, r_{—}2, . . . , r_l)=A_y′ (r_{—}1, r_{—}2, . . . , r_l)=Σ_{i=1}̂l r_i mod b and output. In the restoration algorithm D̂{−1}, D̂{−1}, (w, r)=w+r mod b is output.

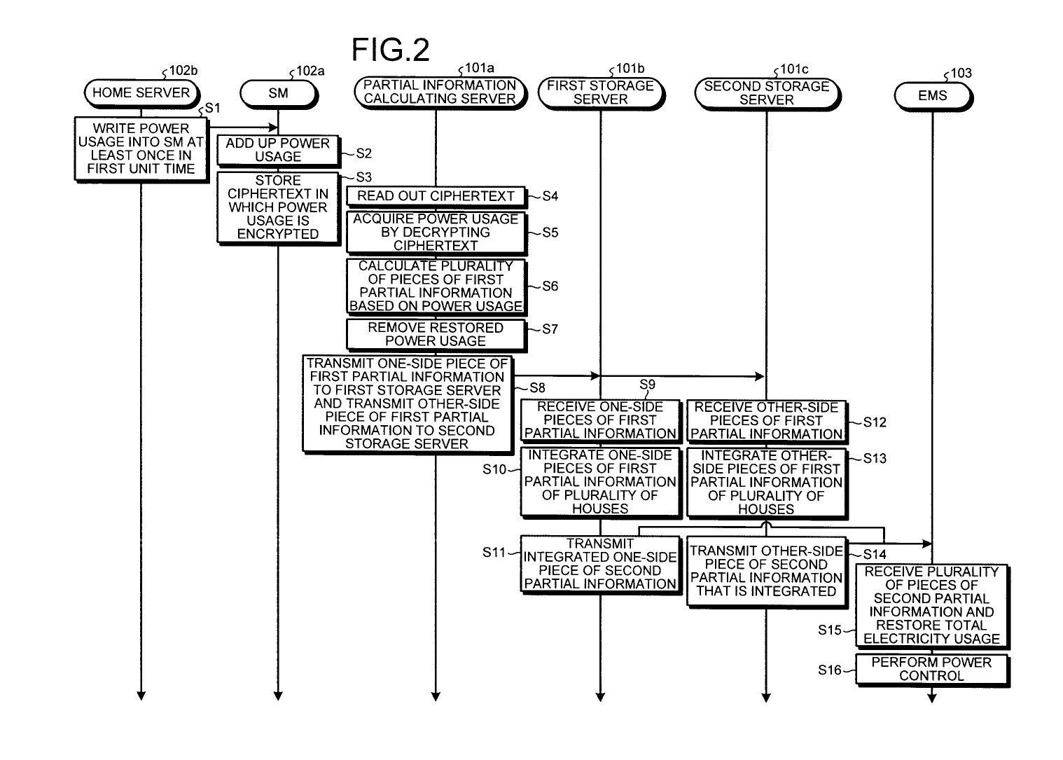

Next, the sequence of processing performed by the power usage calculation system according to this embodiment will be described. First, the sequence of a total power usage calculating process will be described with reference to FIG. 2. The home server 102b writes the power usage of the electric apparatus 102c connected thereto into the SM 102a at least once in the first unit time in Step S1. Similarly, the electric apparatus 102d writes the power usage thereof into the SM 102a at least once in the first unit time. The SM 102a adds up the written power usage z_{i, j} of the electric apparatuses 102c and 102d for every first unit time in Step S2. In a case where the SM 102a mechanically measures the power usage, Step S1 is skipped, and the SM 102a adds up the power usage that is mechanically measured in Step S2. Thereafter, the SM 102a calculates a ciphertext “c_{i, j}=Enc_{ek} (z_{i, j})” by encrypting the power usage z_{i, j} with the encryption key ek and stores the ciphertext c_{i, j} in Step S3. For example, the ciphertext c_{i, j} is stored in a main storage unit.

The partial information calculating server 101a reads out the ciphertext c_{i, j} stored by the SM 102a at least once in the first unit time in Step S4. At this time, the partial information calculating server 101a also reads out house identification information assigned to the house system 102 from the SM 102a. Then, the partial information calculating server 101a acquires the power usage z_{i, j} of the house in the first unit time by decrypting the ciphertext c_{i, j} using the decryption key sk corresponding to the encryption key ek in Step S5. This value is, for example, stored in the main storage unit with being associated with the house identification information. The partial information calculating server 101a calculates a plurality of pieces of the first partial information x_{i, j} and y_{i, j} of power usage of the house in the first unit time using the partial information calculating algorithm D in Step S6 and removes the power usage z_{i, j} acquired in Step S5 from the main storage unit in Step S7. The values of the plurality of pieces of first partial information x_{i, j} and y_{i, j} are, for example, stored in the main storage unit with being associated with the house identification information. The partial information calculating server 101a transmits the one-side piece of the first partial information x_{i, j} to the first storage server 101b together with the house identification information and transmits the other-side piece of the first partial information y_{i, j} to the second storage server 101c together with the house identification information in Step S8. Thereafter, the partial information calculating server 101a removes the plurality of pieces of the first partial information x_{i, j} and y_{i, j} from the main storage unit.

Every first unit time, when one-side pieces of the first partial information x_{—}{1, j}, x_{—}{2, j}, . . . , x_{n, j} and the house identification information of each house are received in Step S9, the first storage server 101b stores them, for example, in an auxiliary storage unit with being associated with the time (power usage time). Then, when the first partial information of a plurality of houses is collected, the first storage server 101b calculates a one-side piece of the second partial information s_j=A_x (x_{—}{1, j}, x_{—}{2, j}) of power usage of the houses in the first unit time by integrating all the first partial information x_{—}{1, j}, x_{—}{2, j}, . . . , x_{n, j} of the power usage of the houses using the integration algorithm A_x in Step S10. The value of the one-side piece of the second partial information is stored, for example, in the main storage unit. The first storage server 101b transmits the one-side piece of the second partial information s_j calculated in Step S10 to the EMS 103 in Step S11. In addition, after Step S11, the first storage server 101b may remove the one-side piece of the second partial information s_j from the main storage unit.

In addition, every first unit time, when the other-side pieces of the first partial information y_{—}{1, j}, y_{—}{2, j}, . . . , y_{n, j} of the plurality of houses are received in Step S12, the second storage server 101c stores the received first partial information, for example, in the auxiliary storage unit with being associated with the time (power usage time). Then, the second storage server 101c calculates all the other-side pieces of the second partial information t_j=A_y (y_{—}{1, j}, y_{—}{2, j}, . . . , y_{n, j}) of power usage of the houses in the first unit time by integrating all the other-side pieces of the first partial information y_{—}{1, j}, y_{—}{2, j}, . . . , y_{n, j} of the power usage of the houses using the integration algorithm A_y in Step S13. The value of the other-side piece of the second partial information is stored, for example, in the main storage unit. The second storage server 101c transmits the other-side piece of the second partial information t_j calculated in Step S13 to the EMS 103 in Step S14. In addition, after Step S14B, the second storage server 101c may remove the other-side piece of the second partial information t_j from the main storage unit.

Every first unit time, when the one-side piece of the second partial information s_j that is transmitted from the first storage server 101b and the other-side piece of the second partial information t_j that is transmitted from the second storage server 101c are received, the EMS 103 restores the total amount of power usage (total power usage) Σ_{i=1}̂n z{i, j}=D̂{−1} (s_j, t_j) of the above-described plurality of houses in the first unit time by integrating a plurality of pieces of the second partial information s_j and t_j using the restoration algorithm D̂{−1} in Step S15. In other words, the EMS 103 integrates the first partial information of each one of a plurality of houses in the first unit time by integrating the one-side piece of the second partial information and the other-side piece of the second partial information and adds up the results and, as a result, acquires the total power usage of the plurality of houses in the first unit time. The received second partial information s_j and t_j and the restored total power usage are stored, for example, in the main storage unit. The EMS 103 performs power control in Step S16 based on the total power usage of all the houses in the first unit time that is restored in Step S15. Then, after the power control is performed, the EMS 103 may remove the plurality of pieces of the second partial information s_j and t_j and the total power usage Σ_{i=1}̂n z{i, j} from the main storage unit.

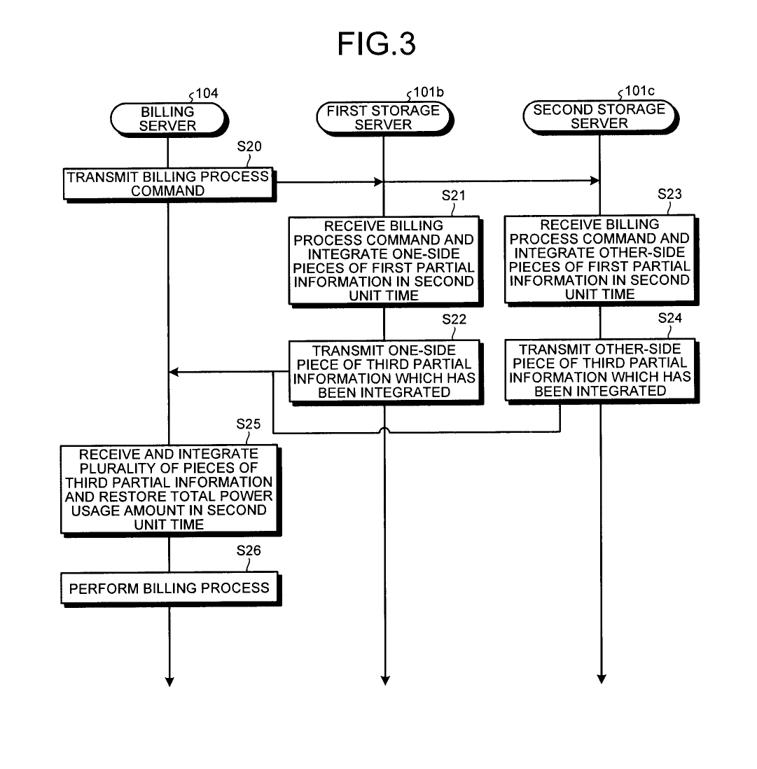

Next, the sequence of a billing system process that is performed by the power usage calculation system will be described. When the above-described total power usage calculating process described with reference to FIG. 2 is performed, the first storage server 101b stores one-side pieces of the first partial information x_{i, 1}, x_{—{i,} 2}, . . . , x_{i, m} of each house in association with the house identification information and the power usage time, and the second storage server 101c stores the other-side pieces of the first partial information y_{i, 1}, y_{i, 2}, . . . , y_{i, m} of each house in association with the house identification information and the power usage time. At this time, the billing server 104 performs a billing process in accordance with the power usage of each house for every second unit time. The sequence of the billing system process including the billing process will be described with reference to FIG. 3. First, the billing server 104 transmits a billing process command for commanding the execution of the billing system process to the first storage server 101b and the second storage server 101c for every second unit time in Step S20. Here, the transmission of the billing process command may be transmitted not from the billing server 104 but from the first storage server 101b and the second storage server 101c to the billing server 104.

When the billing process command is received, the first storage server 101b calculates a one-side piece of the third partial information “u_i=A_x′ (x_{i, 1}, x_{i, 2}, . . . , x_{i, m})” of power usage of each house in the second unit time by reading out the one-side pieces of the first partial information x_{i, 1}, x_{i, 2}, . . . , x_{i, m} belonging to the second unit time out of one-side pieces of the first partial information corresponding to the house identification information of each house from the auxiliary storage unit and integrating a plurality of one-side pieces of the first partial information x_{i, 1}, x_{i, 2}, . . . , x_{i, m} using the integration algorithm A_x′ in Step S21. The value of the one-side piece of the third partial information is stored, for example, in the main storage unit. The first storage server 101b transmits the one-side piece of the third partial information u_i calculated in Step S21 to the billing server 104 in Step S22. In addition, the first storage server 101b may remove the one-side pieces of the first partial information x_{i, 1}, x_{i, 2}, . . . , x_{i, m} from the auxiliary storage unit: when a predetermined time elapses after the calculation of the one-side piece of the third partial information u_i. Here, the predetermined time is a period during which a reading request for power usage is received from the SM 102a to be described later and, for example, is a three month or the like. In addition, after Step S22, the first storage server 101b may remove the one-side piece of the third partial information u_i from the main storage unit.

When the billing process command is received, the second storage server 101c calculates the other-side piece of the third partial information “v_i=A_y′ (y_{i, 1}, y_{i, 2}, . . . , y_{i, m})” of power usage of each houses in the second unit time by reading out the other-side pieces of the first partial information y_{i, 1}, y_{i, 2}, . . . , y_{i, m} belonging to the second unit time out of the other-side pieces of the first partial information corresponding to the house identification information of each house from the auxiliary storage unit and integrating a plurality of the other-side pieces of the first partial information y_{i, 1}, y_{i, 2}, . . . , y_{i, m} using the integration algorithm A_y′ in Step S23. The value of the other-side piece of the third partial information is stored, for example, in the main storage unit. The second storage server 101c transmits the other-side piece of the third partial information v_i calculated in Step S23 to the billing server 104 in Step S24. In addition, the second storage server 101c may remove the other-side pieces of the first partial information y_{i, 1}, y_{i, 2}, . . . , y_{i, m} from the auxiliary storage unit when a predetermined time elapses after the calculation of the other-side piece of the third partial information v_i. Furthermore, after Step S23, the second storage server 101c may remove the other-side piece of the third partial information v_i from the main storage unit.

Every second unit time, when the one-side piece of the third partial information u_i that is transmitted from the first storage server 101b and the other-side piece of the third partial information v_i that is transmitted from the second storage server 101c are received, the billing server 104 restores the total power usage “Σ_{i=1}̂n z{i, j}=D̂{−1} (u_i, v_i)” of each house in the second unit time by integrating a plurality of pieces of the third partial information u_i and v_i using the restoration algorithm D̂{−1} in Step S25. In other words, the billing server 104 integrates a plurality of pieces of the first partial information belonging to the second unit time by integrating the one-side piece of the third partial information and the other-side piece of the third partial information for each house and adds up the results and, as a result, can acquire the total power usage of each house in the second unit time. The billing server 104 performs a billing process for each house in Step S26 based on the total power usage that is restored in Step S25.

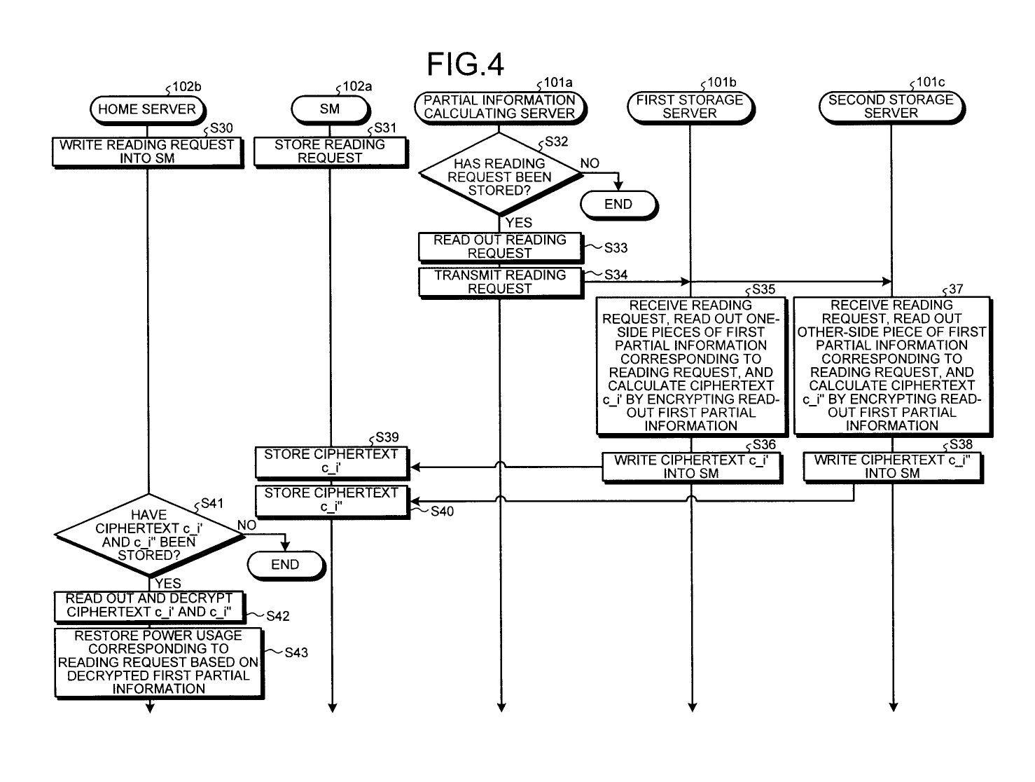

Next, the sequence of a reading request process that is performed by the power usage calculation system will be described. When the above-described total usage power calculating process described with reference to FIG. 2 is performed, the first storage server 101b stores one-side pieces of the first partial information x_{i, 1}, x_{i, 2}, . . . , x_{i, m} of each house in association with the house identification information and the power usage time, and the second storage server 101c stores the other-side pieces of the first partial information y_{i, 1}, y_{i, 2}, . . . , y_{i, m} of each house in association with the house identification information and the power usage time. At this time, the house system 102 generates a reading request that is used for requesting the MDMS 101 to read the power usage. The reading request Req_i includes an identifier that is assigned to the house system 102 and a desired period (referred to as a desired reading period) in which the amount of electricity usage is read. The sequence of the reading request process according to this reading request will be described with reference to FIG. 4.

The home server 102b of the house system 102 writes a reading request Req_i that is used for requesting the SM 102a to read the power usage in Step S30. As a result, the reading request Req_i is stored in the SM 102a in Step S31. While the partial information calculating server 101a, as illustrated in Step S4 of FIG. 2, reads out a ciphertext of power usage in the first unit time from the SM 102a at least once in the first unit time, at this time, the partial information calculating server 101a determines whether or not the reading request Req_i is stored in the SM 102a in Step S32. In a case where it is determined that the reading request Req_i is not stored (No in Step S32), the partial information calculating server 101a ends the reading request process, but, in a case where it is determined that the reading request Req_i is stored (Yes in Step S32), the partial information calculating server 101a reads out the reading request Req_i from the SM 102a and stores the reading request in the main storage unit in Step S33. In addition, after Step S33, the partial information calculating server 101a may remove the reading request Req_i from the SM 102a. Next, the partial information calculating server 101a transmits the reading request Req_i to the first storage server 101b and the second storage server 101c in Step S34. In addition, thereafter, the partial information calculating server 101a may remove the reading request Req_i from the main storage unit.

When the reading request Req_i is received, the first storage server 101b calculates a ciphertext c_i′ by reading out one-side pieces of the first partial information x_{i, 1}, x_{i, 2}, . . , x_{i, l} that correspond to the power usage time within the reading period out of one-side pieces of the first partial information that is stored in association with the house identification information that is included in the reading request Req_i and encrypts the read-out first partial information with the encryption key ek′ in Step S35. The calculated ciphertext c_i′ is stored, for example, in the main storage unit. The first storage server 101b writes the ciphertext c_i′ into the SM 102a in Step S36. As a result, the ciphertext c_i′ is stored in the SM 102a in Step S39. The writing of the ciphertext c_i′ may be performed through the network 106 or may be performed through the partial information calculating server 101a and the network 106. In addition, after Step S36, the first storage server 101b may remove the ciphertext c_i′ from the main storage unit.

When the reading request Req_i is received, the second storage server 101c calculates a ciphertext c_i″ by reading out the other-side pieces of the first partial information y_{i, 1}, y_{i, 2}, . . . , y_{i, l} that correspond to the power usage time within the reading request period out of the other-side pieces of the first partial information that is stored in association with the house identification information that is included in the reading request Req_i and encrypts the read-out first partial information with the encryption key ek″ in Step S37. The calculated ciphertext c_i″ is stored, for example, in the main storage unit. The second storage server 101c writes the ciphertext c_i″ into the SM 102a in Step S38. As a result, the ciphertext c_i″ is stored in the SM 102a in Step S40. The writing of the ciphertext c_i″ may be performed through the network 106 or may be performed through the partial information calculating server 101a and the network 106. In addition, after Step S38, the second storage server 101c may remove the ciphertext c_i″ from the main storage unit.

The home server 102b, as illustrated in Step S1 of FIG. 2, writes the power usage of the electric apparatus 102c into the SM 102a at least once in the first unit time and, at this time, determines whether or not the ciphertexts c_i′ and c_i″ are stored in the SM 102a in Step S41. In a case where the SM 102a mechanically measures the power usage, and Step S1 is not performed, after a reading request is performed in Step S30, the home server 102b may determine whether or not the ciphertexts c_i′ and c_i″ are stored in the SM 102a. In a case where it is determined that the ciphertexts c_i′ and c_i″ are not stored in the SM 102a (No in Step S41), the home server 102b ends the reading request process, and, in a case where it is determined that the ciphertexts c_i′ and c_i″ are stored in the SM 102a (Yes in Step S41), the home server 102b reads out the ciphertexts c_i′ and c_i″ from the SM 102a. Then, the home server 102b decrypts the ciphertext c_i′ by using the decryption key dk corresponding to the encryption key ek′, decrypts the ciphertext c_i″ by using the decryption key dk″ corresponding to the encryption key ek″, and acquires one-side pieces of the first partial information x_{i, 1}, x_{i, 2}, . . . , x_{i, l} and the other-side pieces of the first partial information y_{i, 1}, y_{i, 2}, . . . , y_{i, l} within the reading request period that correspond to the house identification information included in the reading request in Step S42. The home server 102b restores the power usage z_{i, j}=D̂{−1} (x_{i, j}, v_{i, j}) within the reading request period by integrating a plurality of pieces of the first partial information x_{i, j} and y_{i, j} for j=1, 2, . . . , l by using the restoration algorithm D̂{−1} in Step S43. For example, after a reading process such as displaying the power usage on a display unit is performed, the home server 102b ends the reading request process. In addition, the home server 102b may remove the ciphertexts c_i′ and c_i″ from the SM 102a after Step S43. Furthermore, in a case where the partial information calculating server 101a does not remove the request Req_i from the SM 102a, the home server 102b may remove the request Req_i from the SM 102a.

As described above, in this embodiment, the power usage of each house in the first unit time is stored in a plurality of storage servers 101b and 101c of the MDMS 101 as the first partial information in a fragmented manner. Accordingly, even to a supervisor of some of the storage servers and an unauthorized user intruding into some of the storage servers, the power usage of each house is not leaked, and accordingly, the privacy of each house can be protected. In other words, a supervisor of a storage server and an unauthorized user intruding into some of the storage servers may not acquire the power usage of each house for every first unit time and may not estimate whether or not the house is at work, the state of an activity, and the like, whereby the privacy of each house can be protected.

In addition, in this embodiment, the EMS 103 is used, which calculates the total usage amount of all the houses in the first unit time for performing power control as an application server, and a plurality of the storage servers 101b and 101c of the MDMS 101 calculates a plurality of pieces of the second partial information for the power usage of all the houses in the first unit time based on the partial information of the power usage of each house in the first unit time and transmits the results to the EMS 103. As a result, while the EMS 103 can restore the total usage amount of all the houses in the first unit time, the power usage of each house in the first unit time may not be calculated, and accordingly, the privacy of each house can be protected.

In addition, as an application server, while the billing server 104 is used, which calculates the total power usage of each house in the second unit time for performing a billing process of each house, a plurality of the storage servers 101b and 101c of the MDMS 101 calculates a plurality of pieces of the third partial information for the power usage of each house in the second unit time based on the partial information of the power usage of each house in the first unit time and transmits the results to the billing server 104. As a result, while the billing server 104 can restore the total usage amount of each house in the second unit time, the power usage of each house in the first unit time may not be calculated, and accordingly, the privacy of each house can be protected.

### Second Embodiment

Next, a power usage calculation system according to a second embodiment will be described. Each part that is common to the above-described first embodiment will be described with the same reference numeral assigned thereto, or the description thereof will not be presented.

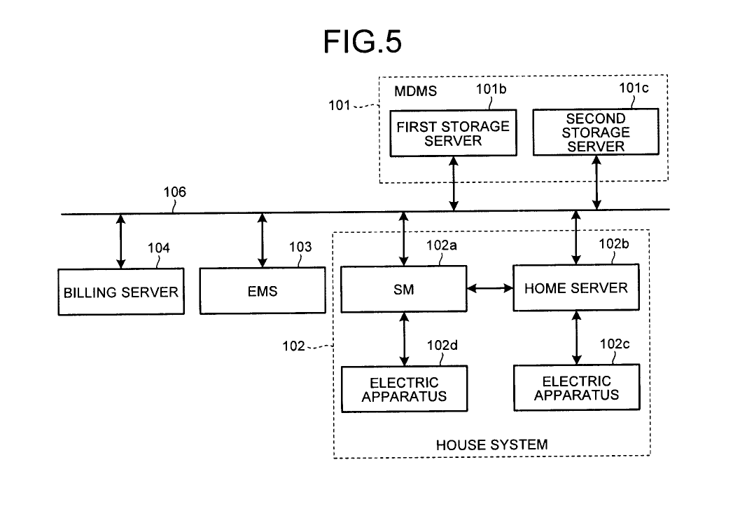

FIG. 5 is a diagram that illustrates an example of the configuration of the power usage calculation system according to this embodiment. As illustrated in the figure, in this embodiment, an MDMS 101 includes a first storage server 101b and a second storage server 101c, but does not include a partial information calculating server 101a. In this embodiment, a home server 102b of a house system 102 has the function of the above-described partial information calculating server 101a. An SM 102a and electric apparatuses 102c and 102d of the house system 102, an EMS 103, and the billing server 104 are almost the same as those of the above-described first embodiment. Next, points that are different from the first embodiment in the home server 102b, the SM 102a, the first storage server 101b, and the second storage server 101c will be described.

The home server 102b calculates a plurality of pieces of first partial information based on the power usage z_{i, j} of the electric apparatuses 102c and 102d included in the house system 102 by using the partial information calculating algorithm D for every first time unit. Here, it is also assumed that two pieces of the first partial information are calculated, one of them is denoted by a one-side piece of the first partial information, and the other is denoted by the other-side piece of the first partial information. In addition, since the home server 102b may not acquire the power usage of the electric apparatus 102d that is not arranged thereunder in the first unit time, the home server 102b reads out a ciphertext of the power usage z_{i, j} in the first unit time from the SM 102a. A decryption key sk used for decrypting the ciphertext is stored in the home server 102b. In addition, the home server 102b stores encryption keys ek_1 and ek_2. Then, the home server 102b encrypts the one-side piece of the first partial information with the encryption key ek_1, writes the encrypted one-side piece of the first partial information into the SM 102a, encrypts the other-side piece of the first partial information with the encryption key ek_2, and writes the encrypted other-side piece of the first partial information into the SM 102a.

The SM 102a stores a first reading request read flag and a second reading request read flag therein. The first reading request read flag represents whether or not the first storage server 101b has read out a reading request Req_i and has an initial value of “0”, and the value is updated to “1” when the first storage server 101b has read out a reading request Req_i. The second reading request read flag represents whether or not the second storage server 101c has read out a reading request Req_i and has an initial value of “0”, and the value is updated to “1” when the second storage server 101c has read out a reading request Req_i.

The first storage server 101b stores a decryption key sk_1 corresponding to the encryption key ek_1 and, by reading a ciphertext in which the one-side piece of the first partial information is encrypted from the SM 102a and decrypting the ciphertext with the decryption key sk_1, acquires a one-side piece of the first partial information and stores the one-side piece of the first partial information in association with house identification information and a power usage time. In addition, the first storage server 101b determines whether or not the above-described reading request is stored in the SM 102a, and, in a case where the determination result is positive, determines whether or not the second storage server 101c has read out the reading request, and, in a case where the determination result is positive, reads out a one-side piece of the first partial information according to the reading request, calculates a ciphertext in which the one-side piece of the first partial information is encrypted, and writes the ciphertext into the SM 102a. It can be determined whether or not the second storage server 101c has read out the reading request by referring to the value of the second reading request read flag. In addition, after the reading request is read out from the SM 102a, the first storage server 101b updates the value of the first reading request read flag, which is stored in the SM 102a, to “1”.

The second storage server 101c stores a decryption key sk_2 corresponding to the encryption key ek_2 and, by reading a ciphertext in which the other-side piece of the first partial information is encrypted from the SM 102a and decrypting the ciphertext with the decryption key sk_2, acquires the other-side piece of the first partial information and stores the other-side piece of the first partial information in association with house identification information and a power usage time. In addition, the second storage server 101c determines whether or not the above-described reading request is stored in the SM 102a, and, in a case where the determination result is positive, determines whether or not the first storage server 101b has read out the reading request, and, in a case where the determination result is positive, reads out the other-side piece of the first partial information according to the reading request, calculates a ciphertext in which the other-side piece of the first partial information is encrypted, and writes the ciphertext into the SM 102a. It can be determined whether or not the first storage server 101b has read out the reading request by referring to the value of the first reading request read flag. In addition, after the reading request is read out from the SM 102a, the second storage server 101c updates the value of the second reading request read flag, which is stored in the SM 102a, to “1”.

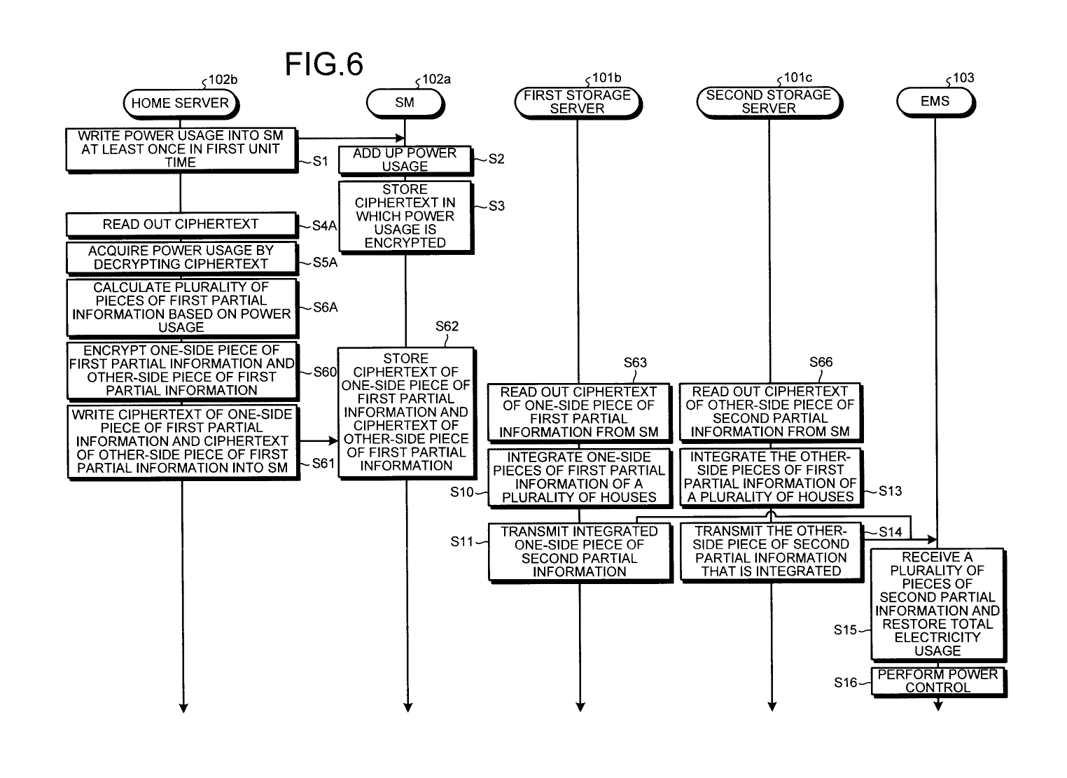

Next, the sequence of the process that is performed by the power usage calculation system according to this embodiment will be described. Since the sequence of the billing system process is the same as that of the above-described first embodiment, the description thereof will not be presented. First, the sequence of the total power usage calculating process will be described with reference to FIG. 6. Steps S1 to S3 are same as those of the above-described first embodiment. In Step S4A, the home server 102b reads out a ciphertext c_{i, j} stored in the SM 102a at least once in the first unit time. Then, the home server 102b acquires power usage z_{i, j} of the house in the first unit time by decrypting the ciphertext c_{i, j} by using the decryption key sk corresponding to the encryption key ek in Step S5A. This value is stored, for example, in the main storage unit with being associated with identification information. In addition, the home server 102b calculates a plurality of pieces of the first partial information x_{i, j} and y_{i, j} for the power usage of the house in the first unit time by using the partial information calculating algorithm D in Step S6A. Furthermore, after Step S6A, the home server 102b may remove the power usage z_{i, j} from the main storage unit. The calculated values of the plurality of pieces of the first partial information x_{i, j} and y_{i, j} are stored, for example, in the main storage unit with being associated with the identification information. The home server 102b calculates a ciphertext “c_{—}{1, i, j}=Enc_{ek_1} (x_{i, j})” by encrypting the one-side piece of the first partial information x_{i, j} with the encryption key ek_1. In addition, the home server 102b calculates a ciphertext “c_{—}{2, i, j}=Enc_{ek_2} (y_{i, j})” by encrypting the other-side piece of the first partial information y_{i, j} with the encryption key ek_2 in Step S60. Here, c_{k, i, j} represents a ciphertext to be received by a k-th storage server for k=1 or 2. In addition, it may be configured such that server identification information used for identifying the k-th storage server is assigned to the k-th storage server, and the server identification information is also added in the ciphertext. Then, the home server 102b writes the ciphertexts c_{—}{1, i, j} and c_{—}{2, i, j} into the SM 102a in Step S61. As a result, the ciphertexts c_{—}{1, i, j} and c_{—}{2, i, j} are stored in the SM 102a in Step S62.

Every first unit time, the first storage server 101b reads out the ciphertext c_{—}{1, i, j} and the house identification information from the SM 102a in Step S63. Thereafter, the first storage server 101b may remove the ciphertext c_{—}{1, i, j} from the SM 102a. Thereafter, in Step S10, the first storage server 101b acquires a one-side piece of the first partial information x_{i, j} by decrypting the ciphertext c_{—}{1, i, j} using a decryption key dk_1 corresponding to the encryption key ek_1 and stores the one-side piece of the first partial information in association with the house identification information and the power usage time. In Step S11, when the one-side pieces of the first partial information x_{—}{1, j}, x_{—}{2, j}, . . . , x_{n, j} of a plurality of houses are collected for every first unit time, the first storage server 101b calculates one-side piece of the second partial information “s_j=A_x (x_{—}{1, j}, x_{—}{2, j}, . . . , x_{n, j})” of the power usage of all the houses in the first unit time by integrating one-side pieces of the first partial information x_{—}{1, j}, x_{—}{2, j}, . . . x_{n, j} of all the houses using the integration algorithm A_x.

In addition, every first unit time, the second storage server 101c reads out the ciphertext c_{—}{2, i, j} and the house identification information from the SM 102a in Step S66. Thereafter, the second storage server 101c may remove the ciphertext c_{—}{2, i, j} from the SM 102a. Thereafter, in Step S13, the second storage server 101c acquires the other-side piece of the first partial information y_{i, j} by decrypting the ciphertext c_{—}{2 i, j} using the decryption key dk_1 corresponding to the encryption key ek_2 and stores the other-side piece of the first partial information in association with the house identification information and the power usage time. In Step S14, when the other-side pieces of the first partial information y_{—}{1, j}, y_{—}{2, j}, . . . , y_{n, j} of a plurality of houses are collected for every first unit time, the second storage server 101c calculates the other-side piece of the second partial information “t_j=A_y (y_{—}{1, j}, y_{—}{2, j}, . . . , y_{n, j})” of the power usage of all the houses in the first unit time by integrating the other-side pieces of the first partial information y_{—}{1, j}, y_{—}{2, j}, . . . , y_{n, j} of all the houses using the integration algorithm A_x. Steps S15 to S16 are the same as those of the above-described first embodiment.

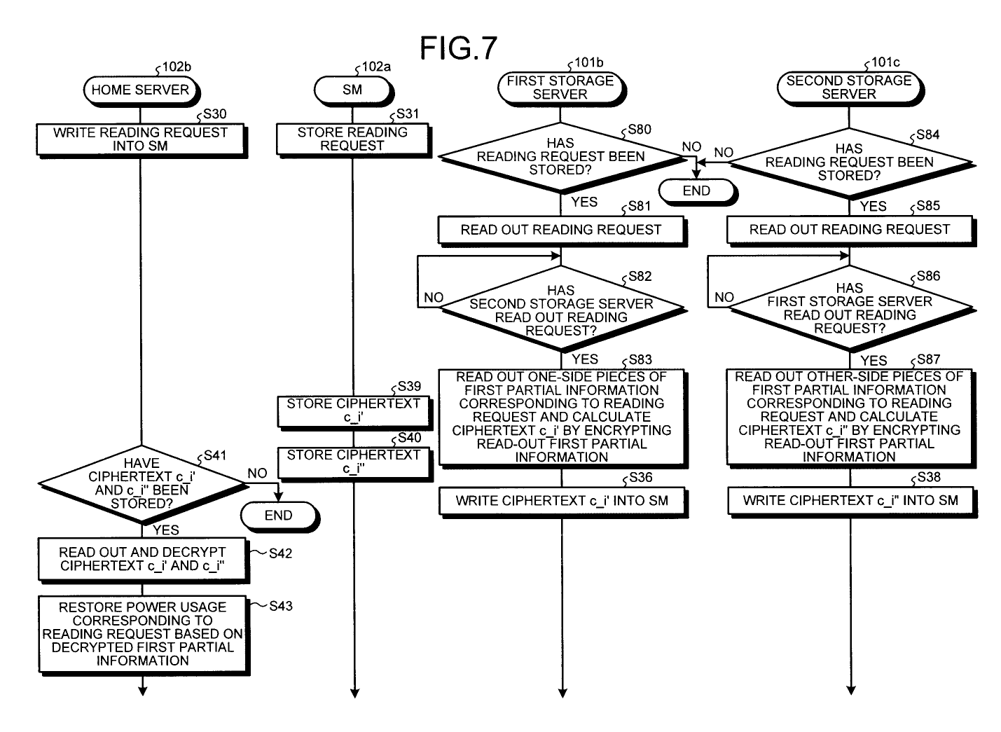

Next, the sequence of a reading request process that is performed by the power usage calculation system will be described with reference to FIG. 7. Steps S30 to S31 are the same as those of the above-described first embodiment. The first storage server 101b, as illustrated in Step S63 of FIG. 6, reads out a ciphertext of a one-side piece of the first partial information from the SM 102a at least once in the first unit time and, at this time, determines whether or not a reading request Req_i is stored in the SM 102a in Step S80. In a case where the reading request Req_i is determined not to be stored (No in Step S80), the first storage server 101b ends the reading request process, but, in a case where the reading request Req_i is determined to be stored (Yes in Step S80), the first storage server 101b reads out the reading request Req_i from the SM 102a and stores the reading request in the main storage unit in Step S81. In addition, after Step S81, the first storage server 101b updates the value of the first reading request read flag stored in the SM 102a to “1” so as to represent that the reading request Req_i has been read out. Thereafter, the first storage server 101b determines whether or not the second storage server 101c has read out the reading request by referring to the value of the second reading request read flag stored in the SM 102a in Step S82. In a case where the second storage server 101c is determined to have read out the reading request (Yes in Step S82), the first storage server 101b calculates a ciphertext c_i′ by reading out one-side pieces of the first partial information x_{i, 1}, x_{—{i,} 2}, . . , x_{i, l} corresponding to the power usage time within the reading request period out of one-side pieces of the first partial information that is stored in association with the house identification information included in the reading request Req_i and encrypting the read-out first partial information with the encryption key ek′ in Step S83. In addition, in such a case, the first storage server 101b may remove the reading request Req_i from the main storage unit and initialize the first reading request read flag and the second reading request read flag. Step S36 is the same as that of the above-described first embodiment.

The second storage server 101c reads out a ciphertext of the other-side piece of the first partial information from the SM 102a at least once in the first unit time and, at this time, determines whether or not a reading request Req_i is stored in the SM 102a in Step S84. In a case where the reading request Req_i is determined not to be stored (No in Step S84), the second storage server 101c ends the reading request process, but, in a case where the reading request Req_i is determined to be stored (Yes in Step S84), the second storage server 101c reads out the reading request Req_i from the SM 102a and stores the reading request in the main storage unit in Step S85. In addition, after Step S85, the second storage server 101c updates the value of the second reading request read flag stored in the SM 102a to “1” so as to represent that the reading request Req_i has been read out. Thereafter, the second storage server 101c determines whether or not the first storage server 101b has read out the reading request by referring to the value of the first reading request read flag stored in the SM 102a in Step S86. In a case where the first storage server 101b is determined to have read out the reading request (Yes in Step S86), the second storage server 101c calculates a ciphertext c_i″ by reading out the other-side pieces of the first partial information y_{i, 1}, y_{i, 2}, . . . , y_{i, l} corresponding to the power usage time within the reading request period out of the other-side pieces of the first partial information that is stored in association with the house identification information included in the reading request Req_i and encrypting the read-out first partial information with the encryption key ek″ in Step S87. In addition, in such a case, the second storage server 101c may remove the reading request Req_i from the main storage unit and initialize the first reading request read flag and the second reading request read flag. Steps S38 to S43 are the same as those of the above-described first embodiment.

According to the configuration described above, similarly to the above-described first embodiment, the power usage of each house in the first unit time is stored in a plurality of the storage servers 101b and 101c of the MDMS 101 in a fragmented manner, and therefore, the privacy of each house can be protected. In addition, also for the EMS 103, the power usage of each house in the first unit time is concealed while the total power usage of all the houses in the first unit time can be restored, whereby the privacy of each house can be protected. Furthermore, also for the billing server 104, the power usage of each house in the first unit time is concealed while the total power usage of each house in the second unit time can be restored, whereby the privacy of each house can be protected.

### Third Embodiment

Next, a power usage calculation system according to a third embodiment will be described. Each part that is common to the above-described first or second embodiment will be described with the same reference numeral assigned thereto, or the description thereof will not be presented.

The configuration of the power usage calculation system according to this embodiment is almost the same as that, which is illustrated in FIG. 5, used in the second embodiment. In the above-described first and second embodiments, the SM 102a has a configuration in which information stored therein is read out or written by external devices such as the first storage server 101b and the second storage server 101c. In this embodiment, the SM 102a, under a predetermined condition, has a function of voluntarily transmitting information and furthermore has a function of performing encrypted communication. Since the SM 102a performs encrypted communication, encryption of the first partial information that is transmitted or received by the SM 102a does not need to be encrypted. Accordingly, the SM 102a may not store the encryption key ek used for encrypting the power usage added up in the first unit time within the house system 102, the first storage server 101b may not store the decryption key sk_1 that is used for decrypting the ciphertext of a one-side piece of the first partial information, the second storage server 101c may not store the decryption key sk_2 that is used for decrypting the ciphertext of the other-side piece of the first partial information, and the home server 102b may not store the decryption key sk used for decrypting the ciphertext of the power usage z_{i, j}, the encryption key ek_1 corresponding to the decryption key sk_1, and the encryption key ek_2 corresponding to the decryption key sk_2. However, although not clearly described here, in order to perform encrypted communication with the SM 102a by using OpenSSL or the like, the SM 102a and a device that performs encrypted communication with the SM 102a perform encryption of information to be transmitted and decryption of received information.

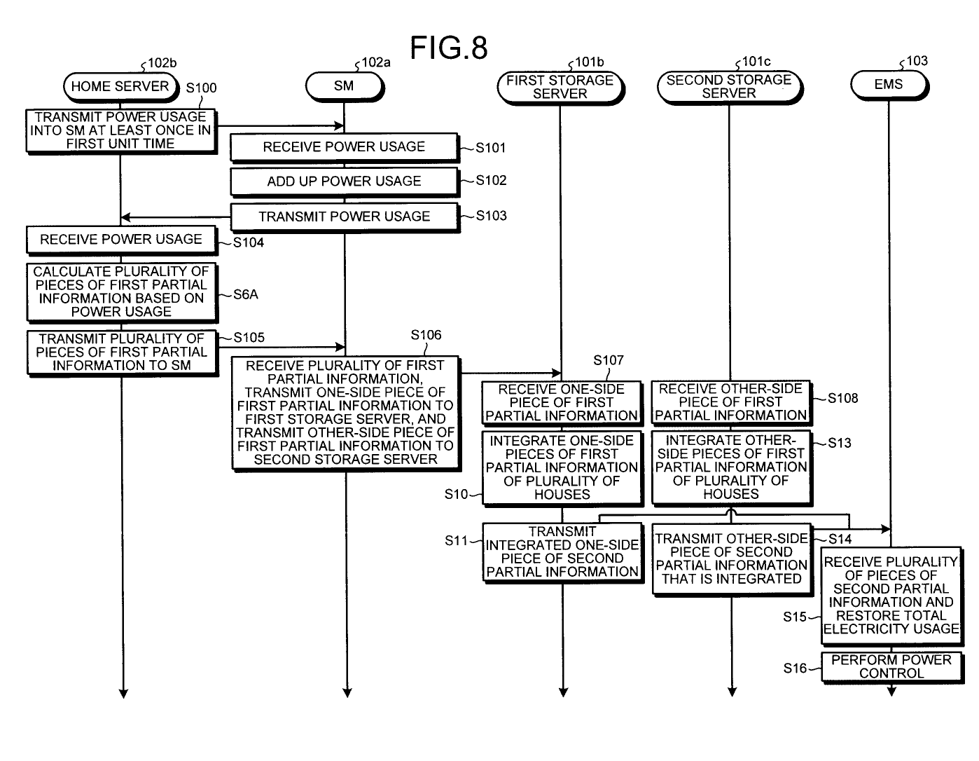

Next, the sequence of the process that is performed by the power usage calculation system according to this embodiment will be described. Since the sequence of the billing system process is the same as that of the above-described first embodiment, the description thereof will not be presented. First, the sequence of the total power usage calculating process will be described with reference to FIG. 8. The home server 102b transmits the power usage of the electric apparatus 102c connected thereto to the SM 102a at least once in the first unit time in Step S100. Similarly, the electric apparatus 102d transmits the power usage thereof to the SM 102a at least once in the first unit time. When the transmitted power usage of the electric apparatuses 102c and 102d is received in Step S101, the SM 102a adds up the power usage z_{i, j} every first unit time in Step S102. In a case where the SM 102a mechanically measures the power usage of the electric apparatuses 102c and 102d, Step S100 is not performed, and the SM 102a adds up the power usage that is mechanically measured in Step S101. The value of the power usage z_{i, j} is stored, for example, in the main storage unit. The SM 102a transmits the power usage z{i, j} added up in Step S102 to the home server 102b at least once in the first unit time in Step S103. After Step S103, the SM 102a may remove the power usage z_{i, j} from the main storage unit.

When the power usage z_{i, j} is received from the SM 102a in Step S104, the home server 102b calculates a plurality of pieces of the first partial information x_{i, j} and y_{i, j} for the power usage of the house in the first unit time by using the partial information calculating algorithm D in Step S6A. The values of the plurality of pieces of the first partial information x_{i, j} and y_{i, j} are stored, for example, in the main storage unit. Then, the home server 102b transmits the plurality of pieces of the first partial information x_{i, j} and y_{i, j} to the SM 102a in Step S105. After Step S105, the home server 102b may remove the plurality of pieces of the first partial information x_{i, j} and y_{i, j} from the main storage unit.

When the plurality of pieces of the first partial information x_{i, j} and y_{i, j} is received from the home server 102b, the SM 102a transmits one-side piece of the first partial information x_{i, j} to the first storage server 101b with being associated with the house identification information and transmits the other-side piece of the first partial information y_{i, j} to the second storage server 101c with being associated with the house identification information in Step S106. After Step S106, the SM 102a may remove the plurality of pieces of the first partial information x_{i, j} and y_{i, j}.

When the one-side piece of the first partial information x_{i, j} and the house identification information are received from the SM 102a in Step S107, the first storage server 101b stores the one-side piece of the first partial information x_{i, j}, the house identification information, and the power usage time in the auxiliary storage unit in association with each other. Steps S10 to S11 are the same as those of the above-described second embodiment. In addition, when the other-side piece of the first partial information y_{i, j} and the house identification information are received from the SM 102a in Step S108, the second storage server 101c stores the other-side piece of the first partial information y_{i, j}, the house identification information, and the power usage time in the auxiliary storage unit in association with each other. Steps S13 to S16 are the same as those of the above-described second embodiment.

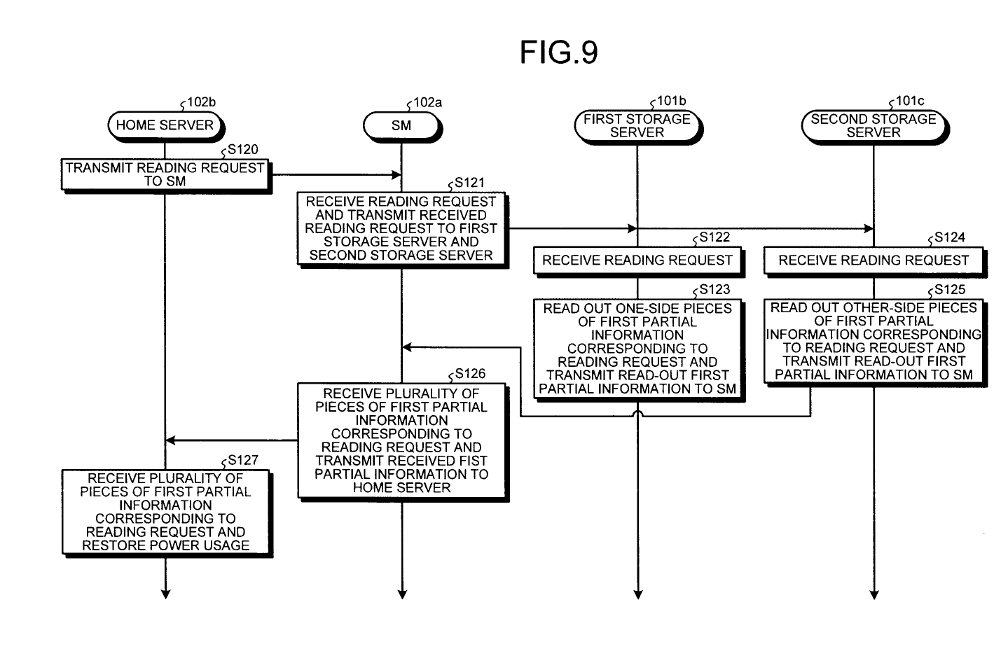

Next, the sequence of a reading request process that is performed by the power usage calculation system will be described with reference to FIG. 9. The home server 102b transmits the above-described reading request Req_i to the SM 102a in Step S120. When the reading request Req_i is received from the home server 102b, the SM 102a transmits the received reading request to the first storage server 101b and the second storage server 101c in Step S121. When the reading request Req_i is received from the SM 102a in Step S122, the first storage server 101b reads out one-side pieces of the first partial information x_{x, 1}, x_{i, 2}, . . . , x_{i, 1} corresponding to the power usage time within the reading request period out of one-side pieces of the first partial information that are stored in association with the house identification information included in the reading request Req_i and transmits the read-out one-side pieces of the first partial information to the SM 102a in Step S123. In addition, when the reading request Req_i is received from the SM 102a in Step S124, the second storage server 101c reads out the other-side pieces of the first partial information y_{i, 1}, y_{i, 2}, . . . , y_{i, l} corresponding to the power usage time within the reading request period out of the other-side pieces of the first partial information that are stored in association with the house identification information included in the reading request Req_i and transmits the read-out other-side pieces of the first partial information to the SM 102a in Step S125.

The SM 102a receives the one-side pieces of the first partial information x_{i, 1}, x_{i, 2}, . . . , x_{i, l} transmitted from the first storage server 101b and the other-side pieces of the first partial information y_{i, 1}, y_{i, 2}, . . . , y_{i, l} transmitted from the second storage server 101c, stores the received pieces of the first partial information, for example, in the main storage unit, and transmits the received pieces of the first partial information to the home server 102b in Step S126. After Step S126, the SM 102a may remove the one-side pieces of the first partial information and the other-side pieces of the first partial information from the main storage unit. Meanwhile, when the one-side pieces of the first partial information x_{i, 1}, x_{i, 2}, . . . , x_{i, l} and the other-side pieces of the first partial information y_{i, 1}, y_{i, 2}, . . . , y_{i, l}, which are transmitted from the SM 102a, are received, the home server 102b restores the power usage z_{i, j}=D̂{−1} (x_{i, j}, v_{i, j}) in the reading request period by integrating a plurality of pieces of the first partial information x_{i, j} and y_{i, j} for j=1, 2, . . , l by using the restoration algorithm D̂{−1} in Step S127.

According to the configuration described above, similarly to the above-described first or second embodiment, the power usage of each house in the first unit time is stored in a plurality of the storage servers 101b and 101c of the MDMS 101 in a fragmented manner, and therefore, the privacy of each house can be protected. In addition, also for the EMS 103, the power usage of each house in the first unit time is concealed while the total power usage of all the houses in the first unit time can be restored, whereby the privacy of each house can be protected. Furthermore, also for the billing server 104, the power usage of each house in the first unit time is concealed while the total power usage of each house in the second unit time can be restored, whereby the privacy of each house can be protected.

### Modified Example

Various modifications as represented as below as examples can be made.

In each embodiment described above, various programs that are executed by at least one of the partial information calculating server 101a, the first storage server 101b, the second storage server 101c, the SM 102a, the home server 102b, the EMS 103, and the billing server 104 may be configured to be stored in a computer connected to a network such as the Internet and to be provided by being downloaded through the network. In addition, various programs described above may be configured to be recorded on a computer-readable recording medium such as a CD-ROM, a flexible disk (FD), a CD-R, or a digital versatile disk (DVD) as a file in an installable format or an executable format and be provided as a computer program product.

In each embodiment described above, although the MDMS 101 includes two storage servers (the first storage server 101b and the second storage server 101c), the MDMS 101 may include three or more storage servers. In such a case, it may be configured such that the partial information calculating server 101a or the home server 102b calculates three or more pieces of the first partial information based on the power usage in the first unit time that is added up by the SM 102a, and the first partial information is stored in three or more storage servers in a fragmented manner. In addition, the first partial information calculated based on the power usage in the first unit time may be configured to be stored in not all but some of the plurality of storage servers in a fragmented manner. Furthermore, the partial information calculating server 101a of the MDMS 101 and the plurality of storage servers do not need to be present at the same location but may be connected through the network 106 or managed by different companies.

In addition, in each embodiment described above, in the communication between the first storage server 101b and the second storage server 101c and the partial information calculating server 101a, the communication between the first storage server 101b and the second storage server 101c and the billing server 104, the communication between the first storage server 101b and the second storage server 101c and the EMS 103, the communication between the SM 102a and the partial information calculating server 101a, and the communication between the first storage server 101b and the second storage server 101c and the SM 102a, encrypted communication such as OpenSSL may be performed so as to conceal information that is transmitted or received. Furthermore, in each communication, device authentication used for authenticating each other may be performed. However, in the first and second embodiments, since the SM 102a is configured to perform information writing or information reading from external devices such as the first storage server 101b, the second storage server 101c, the home server 102b, and the like, in the SM 102a, for example, in Steps S3, S36, and S38, a ciphertext encrypted with an encryption key is written. Since the partial information calculating server 101a reads out the ciphertext that is already encrypted from the SM 102a as above, encrypted communication may not be performed between the SM 102a and the partial information calculating server 101a. In addition, in the second embodiment, since the first storage server 101b and the second storage server 101c read out a ciphertext from the SM 102a, encrypted communication may not be performed between the first storage server 101b and the SM 102a or between the second storage server 101c and the SM 102a.

In each embodiment described above, although the EMS 103 and the billing server 104 are used as application servers, other than these, a power transaction service server that manages power distribution may be used. For example, in a case where the unit price of electric power is determined based on the total power usage of a plurality of houses in the first unit time, the power transaction service server, similarly to the EMS 103, may receive a one-side piece of the second partial information from the first storage server 101b, receive the other-side piece of the second partial information from the second storage server 101c, determine a unit price of the electric power by restoring the total power usage of the plurality of houses in the first unit time, and perform a power transaction. In addition, a power-saving application server that performs power control of each house in cooperation with the home server 102b may be used as an application server. In such a case, the power-saving application server, instead of performing power control of each house by using the power usage of each house in the first unit time, similarly to the EMS 103, may receive a one-side piece of the second partial information from the first storage server 101b, receive the other-side piece of the second partial information from the second storage server 101c, perform power control of each house by using the total usage amount of the plurality of houses in the first unit time, which is calculated based on a plurality of pieces of the second partial information or, similarly to the billing server 104, may receive a one-side piece of the third partial information (or information corresponding to a one-side piece of the third partial information calculated based on the one-side piece of the first partial information in a part of the second unit time) from the first storage server 101b, receive the other-side piece of the third partial information (or information corresponding to the other-side piece of the third partial information calculated based on the other-side piece of the first partial information in a part of the second unit time) from the second storage server 101c, and perform power control of each house by using the power usage of each house in the second unit time (or a part time of the second unit time) that is calculated based on a plurality of pieces of the third partial information (or information corresponding thereto).

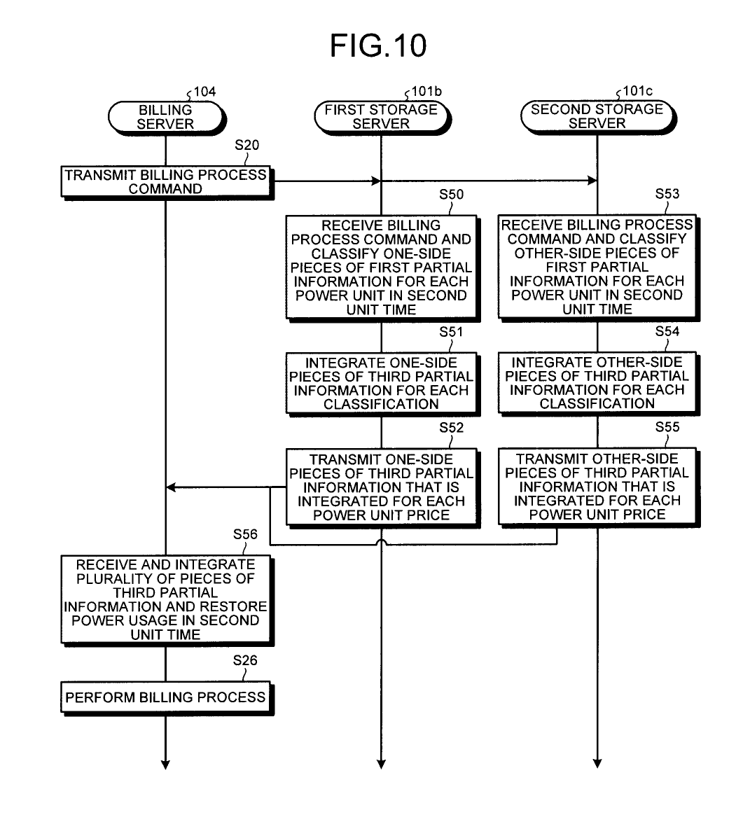

In the first embodiment described above, the billing server 104 performs a billing process based on the total power usage of each house in the second unit time. In a smart grid, there is a case where the billing unit rises (the unit cost of electric power becomes high) in a time zone in which the amount of usage of the electric power is large. Even when such dynamic price purchasing (dynamic price setting) is performed, the billing system process may be performed by using the one-side piece of the first partial information that is stored in the first storage server 101b and the other-side piece of the first partial information that is stored in the second storage server 101c. FIG. 10 is a flowchart that illustrates the sequence of the billing system process according to this modified example. Even in this modified example, similarly to the first embodiment described above, when the total power usage calculating process described with reference to FIG. 2 described above is performed, the first storage server 101b stores one-side pieces of the first partial information x_{i, 1}, x_{i, 2}, . . . , x_{i, m} of each house in association with the house identification information and the power usage time, and the second storage server 101c stores the other-side pieces of the first partial information y_{i, 1}, y_{i, 2}, . . . , y_{i, m} of each house in association with the house identification information and the power usage time. At this time, the billing server 104 performs a billing process in accordance with the power usage of each house and the power usage time for every second unit time. The sequence of the billing system process will be described with reference to FIG. 10. In addition, the electric power price changes for every first unit time or the previous electric power price is used for the first unit time, and k unit prices of electric power included in the second unit time are denoted by p_1, p_{—2}, . . . , p_k. For example, in a case where the unit price of the electric power is constant as 10 yen through the second unit time, k=1 and p_1=10. In addition, in a case where the unit price of electric power at the peak time in a day is 15 yen, the unit price of electric power at midnight is 5 yen, and the unit price is 10 yen at the other time, k=3, and p_1=5 (midnight), p_2=10 (normal time), and p_3=15 (peak time). Instead of time zones in a day, the unit price of the electric power may change in each day.

Step S20 is the same as that of the above-described first embodiment. In Step S50, when a billing process command is received, the first storage server 101b reads out one-side pieces of the first partial information x_{i, 1}, x_{i, 2}, . . , x_{i, m} that belong to the second unit time out of one-side pieces of the first partial information of each house corresponding to the house identification information from the auxiliary storage unit and classifies the one-side pieces of the first partial information so as to be in correspondence with the power unit prices p_1, p_2, . . . , p_k by using the power usage time that is associated thereto. Then, the first storage server 101b calculates one-side pieces of the third partial information u_{i, 1}, u_{i, 2}, . . . , u_{i, k} of the power usage of each house in the second unit time by integrating the one-side pieces of the first partial information by using the integration algorithm A_x for each classified set in Step S51. For example, for l having a value of one of 1, 2, . . . , k, when the one-side pieces of the first partial information corresponding to the power unit price p_l are x_{i, 2}, x_{i, 7}, x_{i, 10}, one-side pieces of the third partial information u_{i, l} corresponding to the power unit price p_l are calculated as u{i, l}=A_x (x_{i, 2}, x_{i, 7}, x_{i, 10}). Here, subscripts i and l in each u_{i, l} of the one-side piece of the third partial information and each v_{i, l} of the other-side piece of the third partial information represent a first unit time corresponding to the house identification information and the power unit price p_l. The first storage server 101b transmits the one-side pieces of the third partial information u_{i, 1}, u_{i, 2}, . . . , u_{i, k} that correspond to the power unit prices p_1, p_2, . . . , p_k to the billing server 104 in Step S52. In addition, it may be configured such that the first storage server 101b calculates the one-side pieces of the third partial information u_{i, 1}, u_{i, 2}, . . . , u_{i, k} and, after a predetermined time elapses, removes the one-side pieces of the first partial information x_{i, 1}, x_{i, 2}, . . . , x_{i, m} of each house from the auxiliary storage unit. Furthermore, the first storage server 101b may remove the one-side pieces of the third partial information u_{i, 1}, u_{i, 2}, . . . , u_{i, k} from the main storage unit after Step 52.

In addition, when a billing process command is received, the second storage server 101c reads out the other-side pieces of the first partial information y_{i, 1}, y_{i, 2}, . . . , y_{i, m} that belong to the second unit time out of the other-side pieces of the first partial information of each house corresponding to the house identification information from the auxiliary storage unit and classifies the other-side pieces of the first partial information so as to be in correspondence with the power unit prices p_1, p_2, . . . , p_k by using the power usage time that is associated therewith in Step S53. Then, the second storage server 101c calculates the other-side pieces of the third partial information v_{i, 1}, v{i, 2}, . . . , v_{i, k} of the power usage of each house in the second unit time by integrating the other-side pieces of the first partial information by using the integration algorithm A_y for each classified set in Step S54. For example, for 1 having a value of one of 1, 2, . . . , k, when the other-side pieces of the first partial information corresponding to the power unit price p_l are y_{i, 2}, y_{i, 7}, y_{i, 10}, the other-side pieces of the third partial information v_{i, l} corresponding to the power unit price p_l are calculated as v_{i, l}=A_y (y_{i, 2}, y_{i, 7}, y_{i, 10}). Here, the second storage server 101c transmits the other-side pieces of the third partial information v_{i, 1}, v_{i, 2}, . . . , v_{i, k} that correspond to the power unit prices p_1, p_2, . . . , p_k to the billing server 104 in Step S55. In addition, it may be configured such that the second storage server 101c calculates the other-side pieces of the third partial information v_{i, 1}, v_{i, 2}, . . . , v_{i, k} and, after a predetermined time elapses, removes the other-side pieces of the first partial information y_{i, 1}, y_{i, 2}, . . . , y_{i, m} of each house from the auxiliary storage unit. Furthermore, the second storage server 101c may remove the other-side pieces of the third partial information v_{i, 1}, v_{i, 2}, . . . , v_{i, k} from the main storage unit after Step 55.

When one-side pieces of the third partial information u_{i, 1}, u_{i, 2}, . . . , u_{i, k} transmitted from the first storage server 101b and the other-side pieces of the third partial information v_{i, 1}, v_{i, 2}, . . , v_{i, k} transmitted from the second storage server 101c are received for every second unit time, the billing server 104 restores the power usage “q_{i, l}=D̂{−1} (u_{i, l}, v_{i, l})” corresponding to the power unit price p_l in the second unit time of each house by integrating a plurality of pieces of the third partial information for l=1, 2, . . . , k by using the restoration algorithm D̂{−1} in Step S56. In Step S26, the billing server 104 performs a billing process by calculating the power usage charge Σ_{l=1}̂k p_l*q_{i, l} of each house based on the power usage corresponding to each power unit price, which is restored in Step S56.

According to the above-described configuration, while the billing server 104 can restore the power usage of each house for each power unit price in the second unit time and can perform a billing process according to the power unit price, the power usage of each house in the first unit time cannot be calculated, and accordingly, the privacy of each house can be protected. In addition, the above-described configuration may be applied to the second embodiment or the third embodiment.

In the above-described second embodiment, instead of Steps S60 and S61, it may be configured such that the home server 102b writes a plurality of pieces of the first partial information x_{i, j}, y_{i, j} into the SM 102a, and the SM 102a calculates a ciphertext c_{—}{1, i, j} by encrypting the one-side piece of the first partial information x_{i, j} with the encryption key ek_1 and calculates a ciphertext c_{—}{2, i, j} by encrypting the other-side piece of the first partial information y_{i, j} with the encryption key ek_2. In such a case, the encryption keys ek_1 and ek_2 are stored not in the home server 102b but in the SM 102a.

In addition, in the above-described second and third embodiments, although the function of the partial information calculating server 101a according to the first embodiment is configured to be included in the home server 102b, the present invention is not limited thereto, and the above-described function may be configured to be included in the SM 102a.

Furthermore, in the above-described first embodiment, although the partial information calculating server 101a calculates a plurality of pieces of the first partial information based on the amount of electricity usage in the first unit time, the present invention is not limited thereto, and the plurality of pieces of the first partial information may be calculated based on the power usage added up at arbitrary timing, or the plurality of pieces of the first partial information may be calculated based on the power usage regardless of the time. This can be similarly applied to a case where the home server 102b calculates the first partial information in the second and third embodiments.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A power usage calculation system in which a data management system, which is connected to a plurality of electric power meters adding up power usage of electric apparatuses, and an energy management system are interconnected through a network, the power usage calculation system comprising:
a first calculator that calculates a plurality of pieces of first partial information by using the power usage added up by the electric power meters,
wherein the data management system includes a plurality of storage servers, the each of the storage servers storing each corresponding pieces of the first partial information
wherein each of the storage servers includes:
a second calculator that calculates second partial information by using a plurality of pieces of the first partial information of the power usage added up by the plurality of the electric power meters; and
a transmission unit that transmits the second partial information to the energy management system,
wherein the energy management system includes:
a first reception unit that receives the second partial information transmitted from the plurality of storage servers; and
a third calculator that calculates a total amount of the power usage added up by the plurality of the electric power meters by using a plurality of pieces of the second partial information, and
wherein the first partial information is information that cannot specify privacy information.

2. The system according to claim 1,
wherein the electric power meter adds up power usage in a first unit time,
wherein the first calculator calculates the plurality of pieces of the first partial information by using the power usage in the first unit time, and
wherein the second calculator calculates the second partial information in the first unit time by using a plurality of pieces of the first partial information of the power usage each of which is added up by each of the plurality of the electric power meters.

3. The system according to claim 2,
wherein the power usage calculation system is connected to an application server through the network,
wherein the second calculator calculates third partial information in a second unit time by using the first partial information of the power usage added up within the second unit time, which is the first partial information of the power usage that is added up by at least one of the electric power meters,
wherein the transmission unit transmits the third partial information to the application server, and
wherein the application server includes:
a second reception unit that receives the third partial information respectively transmitted from the plurality of the storage servers, and
a fourth calculator that calculates a total amount of the power usage added up by at least one of the electric power meters by using a plurality of pieces of the third partial information.

4. The system according to claim 3,
wherein the data management system is connected to a partial information calculating server that include the first calculation unit through the network, and
wherein the partial information calculating server further includes a transmission unit that transmits the plurality of pieces of the first partial information to the storage servers in a fragmented manner.

5. The system according to claim 4, wherein the application server further includes a billing unit that performs a billing process by using the total amount of the power usage.
